(19) United States
(12) Patent Application Publication
(10) Pub. No.: US 2026/0032354 A1
(43) Pub. Date: Jan. 29, 2026

(54) IMAGE-DEBLURRING THROUGH CIS-EVS FUSION

(71) Applicant: OMNIVISION TECHNOLOGIES, INC., SANTA CLARA, CA (US)

(72) Inventors: Bo MU, SAN JOSE, CA (US); Rui JIANG, SINGAPORE (SG); Xuehui LEI, SHANGHAI (CN); Wei ZHANG, SHANGHAI (CN); Tiejun DAI, SANTA CLARA, CA (US)

(21) Appl. No.: 19/279,286

(22) Filed: Jul. 24, 2025

Related U.S. Application Data
(60) Provisional application No. 63/675,346, filed on Jul. 25, 2024.

(51) Int. Cl. H04N 25/61; H04N 25/47; H04N 25/77

(52) U.S. Cl. CPC H04N 25/61; H04N 25/47; H04N 25/77

(57) ABSTRACT

The present disclosure describes an image system comprising a hybrid image sensor and control circuitry. The hybrid sensor includes an event-driven sensing array with multiple event vision sensor (EVS) pixels and a pixel array with multiple CMOS image sensor (CIS) pixels. EVS pixels capture contrast data within a first time interval, while CIS pixels capture light intensity data during second and third time intervals. The control circuitry uses the EVS data to deblur the first CIS data, generates fusion masks and weights based on the EVS and CIS data, and fuses the deblurred and subsequent CIS data using these masks and weights. The second time interval occurs before the third time interval.

### CROSS REFERENCE TO RELATED APPLICATIONS

This application claims priority of U.S. Provisional Application No. 63/675,346 filed on Jul. 25, 2024 under 35 U.S.C. § 119 (e), the entire contents of all of which are hereby incorporated by reference.

### BACKGROUND OF THE INVENTION

### 1. Field of the Invention

The present disclosure relates to an imaging system, and more particularly, to an image system with image-deblurring through CMOS image sensor (CIS)-event vision sensor (EVS) fusion.

### 2. Description of the Related Art

Digital imaging has become ubiquitous in various applications, including consumer electronics, automotive systems, industrial automation, and medical devices. Complementary Metal-Oxide-Semiconductor (CMOS) image sensors (CIS) are widely employed in these applications due to their advantages in terms of cost, power consumption, and integration capabilities. However, a significant challenge in digital imaging, particularly for scenes involving relative motion between the camera and the subject, is image blur. Motion blur can severely degrade image quality, obscuring fine details and hindering subsequent image processing tasks such as object recognition, tracking, and measurement.

Known methods for addressing motion blur in CIS systems often involve strategies of adjusting integration time (exposure time). Increasing integration time can lead to higher signal-to-noise ratios but exacerbate blur in dynamic scenes. Conversely, reducing integration time can mitigate motion blur but results in lower light sensitivity and increased noise, especially in low-light conditions. Other techniques include optical image stabilization (OIS) or electronic image stabilization (EIS), which attempt to compensate for camera motion. While these methods can be effective for minor movements, they may not fully resolve blur caused by rapid subject motion or in scenarios where the motion is complex and unpredictable.

Furthermore, computational deblurring algorithms have been developed to reconstruct sharp images from blurred inputs. These algorithms often rely on deconvolution techniques, such as Wiener filtering or iterative optimization methods. However, the effectiveness of these algorithms is heavily dependent on accurate estimation of the point spread function (PSF), which characterizes the blurring process. Estimating the PSF accurately, especially in the presence of complex or non-uniform motion, remains a computationally intensive and challenging problem. Moreover, such post-processing techniques may introduce artifacts or amplify noise, particularly when the blur is severe or the image information loss is significant.

Separately, Event Vision Sensors (EVS), also known as neuromorphic cameras or dynamic vision sensors (DVS), represent an alternative paradigm for visual sensing. Unlike traditional frame-based image sensors that capture intensity images at fixed rates, EVS pixels asynchronously detect changes in logarithmic intensity (events) and output these events with microsecond temporal resolution. This event-driven approach provides several advantages, including very high temporal resolution, high dynamic range, and low power consumption, especially in static scenes where few events are generated. EVS are particularly adept at capturing rapid motion without motion blur, as each event essentially marks an instantaneous change at a pixel.

While EVS excel at capturing motion information with high temporal fidelity, they typically do not provide dense intensity information, making it difficult to reconstruct full-frame images or to perceive static scenes. The output of an EVS is a sparse stream of events, which presents challenges for applications that require image data. Therefore, there is a need for an improved imaging system that can overcome the limitations of traditional frame-based image sensors in dynamic scenarios while also leveraging the unique capabilities of EVS to provide enhanced image quality, particularly with respect to motion blur. The present disclosure addresses these and other needs.

### SUMMARY OF THE INVENTION

One aspect of the present disclosure provides an image system. The image system comprises a hybrid image sensor and control circuitry. The hybrid image sensor comprises an event driven sensing array and a pixel array. The event driven sensing array includes a plurality of event vision sensor (EVS) pixels arranged in EVS pixel rows. One of the plurality of EVS pixels is configured to capture first EVS data corresponding to contrast information of light incident on that EVS pixel within a first time interval. The pixel array includes a plurality of CMOS image sensor (CIS) pixels arranged in CIS pixel rows. One of the plurality of CIS pixels is configured to capture first CIS data corresponding to intensity of light incident on the CIS pixel within a second time interval and to capture second CIS data corresponding to intensity of light incident on the CIS pixel within a third time interval. The control circuitry is configured to perform operations comprising: using the first EVS data to deblur the first CIS data, generating fusion masks and fusion weights at least partially based on at least one of the first EVS data, the first CIS data and the second CIS data, and fusing the deblurred first CIS data and the second CIS data with the fusion masks and the fusion weights. The second time interval precedes the third time interval.

Another aspect of the present disclosure provides a method of operating an imaging system including a hybrid image sensor. The method comprises: receiving, by control circuitry, first event vision sensor (EVS) data captured from the hybrid image sensor and corresponding to contrast information of light incident on an EVS pixel of the hybrid image sensor within a first time interval; receiving, by the control circuitry, first CMOS image sensor (CIS) data captured from the hybrid image sensor and corresponding to intensity of light incident on a CIS pixel of the hybrid image sensor within a second time interval; receiving, by the control circuitry, second CIS data captured from the hybrid image sensor and corresponding to intensity of light incident on the CIS pixel within a third time interval; deblurring, by the control circuitry, the first CIS data with the first EVS data; generating, by the control circuitry, fusion masks and fusion weights based on at least one of the first EVS data, the first CIS data and the second CIS data; and fusing, by the control circuitry, the deblurred first CIS data and the second CIS data with the fusion masks and the fusion weights. The second time interval precedes the third time interval.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, dimensions of the various features may be arbitrarily increased or reduced for clarity of discussion.

FIG. 1 illustrates a system diagram of an imaging system, in accordance with some embodiments of the present disclosure.

FIG. 2 illustrates an image deblurring process, in accordance with some embodiments of the present disclosure.

FIG. 3 illustrates time diagrams of the event flow and the pixel illuminance, in accordance with some embodiments of the present disclosure.

FIG. 4 illustrates a temporal representation of events suitable for hardware processing, in accordance with some embodiments of the present disclosure.

FIG. 5 illustrates the operations of different mask generations, in accordance with some embodiments of the present disclosure.

FIG. 6 illustrates a process including mask generation and weight strategy for fusion, in accordance with some embodiments of the present disclosure.

FIG. 7 illustrates another image deblurring process, in accordance with some embodiments of the present disclosure.

FIG. 8 illustrates another image deblurring process, in accordance with some embodiments of the present disclosure.

FIGS. 9A-C illustrates the comparative results of different deblurring techniques, in accordance with some embodiments of the present disclosure.

### DETAILED DESCRIPTION OF THE DISCLOSURE

The present disclosure pertains to hybrid image sensors, as well as the systems, devices, and methods associated therewith. Specifically, several embodiments of the technology described herein are directed to hybrid image sensors comprising active pixels, such as complementary metal-oxide-semiconductor (CMOS) image sensor (CIS) pixels, in conjunction with event vision sensor (EVS) pixels. Additionally, the disclosure addresses methods for operating such hybrid image sensors to accommodate varying resolutions between CIS and EVS. In the ensuing description, specific details are provided to facilitate a comprehensive understanding of the aspects of the present technology. It is acknowledged that those skilled in the relevant field will recognize that the systems, devices, and techniques described herein may be implemented without one or more of the specific details provided, or may employ alternative methods, components, materials, and the like.

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from normal deviation found in the respective testing measurements. Also, as used herein, the terms “substantially,” “approximately” and “about” generally mean within a value or range that can be contemplated by people having ordinary skill in the art. Alternatively, the terms “substantially,” “approximately” and “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages, such as those for quantities of materials, durations of times, temperatures, operating conditions, ratios of amounts, and the likes thereof disclosed herein, should be understood as modified in all instances by the terms “substantially,” “approximately” or “about.” Accordingly, unless indicated to the contrary, the numerical parameters set forth in the present disclosure and attached sections describing the inventions are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

A CMOS image sensors (CIS) utilizes an array of pixels designed to capture intensity images and video of an external scene. More specifically, these pixels are employed to acquire CIS information (e.g., intensity data) corresponding to light from the external scene that impinges upon the pixels. The CIS information collected during an integration period is subsequently read out at the conclusion of that period and utilized to generate a corresponding intensity image of the external scene.

The pixels within a CIS typically operate under a globally defined integration time. Consequently, the pixels in the array of the CIS generally share an identical integration time, and each pixel in the array is converted into a digital signal irrespective of its content (e.g., regardless of whether there has been a change in the external scene captured by a pixel since its last readout). As a result, the operation of the CIS at high frame rates may necessitate a substantial amount of memory and power. Therefore, due in part to constraints related to memory and power, it is challenging to utilize an active pixel sensor independently to capture intensity images and video of an external scene at ultra-high frame rates.

A frame-based camera equipped with a CIS offers numerous advantages, including synchronous images, spatial dense information, adjustable exposure, and image absolute intensity. For a global shutter CIS, synchronous image capture is allowed to ensure that all pixels are exposed simultaneously. This feature eliminates the risk of roller shutter distortion that may occur with sequential image capture. As a result, the frame camera can accurately capture fast-moving objects or scenes with high dynamic ranges. The CIS provides spatial dense information, meaning that it can capture a large number of pixels in a given area. This high pixel density enables the camera to capture fine details and produce high-resolution images. Whether it is for scientific research, surveillance, or professional photography, the frame camera with a CIS can deliver sharp and detailed images.

The CIS may further incorporate a feature of adjustable exposure time. This feature allows the camera to adapt to different lighting conditions and capture images with optimal brightness and contrast. By adjusting the exposure settings, users can ensure that their images are properly exposed, even in challenging lighting situations. Furthermore, the CIS offers image absolute intensity, which refers to the ability to accurately measure the intensity of light in an image. This feature is particularly useful in scientific applications, where precise measurements are required. With a CIS, the frame camera can provide accurate and reliable intensity measurements, making it suitable for various scientific experiments and research. The CIS is also well-suited for capturing static scenes. It excels in capturing still images with minimal noise and distortion. This makes it ideal for applications such as landscape photography, architectural photography, or any situation where a stable and clear image is desired.

Furthermore, when motion or other alterations occur in an external scene during an integration period, motion artifacts may manifest as blurring in the resulting intensity image of the external scene. This blurring can be particularly pronounced under low light conditions, where longer exposure times are employed. Consequently, CISs, when used in isolation, are not particularly effective at capturing sharp intensity images and video of highly dynamic scenes.

In contrast, EVSs (e.g., event-driven sensors or dynamic vision sensors) utilize EVS pixels that are capable of acquiring non-CIS information (e.g., contrast information, intensity variations, event data) corresponding to light from an external scene incident upon those EVS pixels. EVSs read out an EVS pixel and/or convert the corresponding pixel signal into a digital signal only when the EVS pixel detects a change (e.g., an event) in the external scene. In other words, EVS pixels of an event vision sensor that do not detect a change in the external scene remain unread and/or the pixel signals corresponding to such EVS pixels are not converted into digital signals, thereby conserving power. Consequently, each EVS pixel of an event vision sensor operates independently of the other EVS pixels within the same sensor, and only those EVS pixels that detect a change in the external scene are read out and/or have their corresponding pixel signals converted into digital signals. As a result, unlike CISs with synchronous integration times, event vision sensors are not constrained by limited dynamic ranges and are capable of accurately capturing high-speed motion. Therefore, EVSs are often more robust than CISs under low-light conditions and/or in highly dynamic scenes, as they are not adversely affected by underexposure, overexposure, or motion blur associated with a synchronous shutter. In summary, EVSs facilitate ultra-high data update rates and enable precise capture of high-speed motions.

EVSs revolutionize the way we capture and process visual information. Unlike CISs that merely capture images at a fixed rate, EVSs operate on a completely different principle, offering several advantages that make them highly desirable in various applications. One of the key advantages of EVSs is their ability to capture asynchronous data. Instead of capturing frames at a fixed rate, EVSs only capture and transmit data when there is a change (change in light intensity) in the scene. This means that they are extremely efficient in terms of data transmission and storage, as they only capture and transmit the relevant information. This asynchronous nature allows EVSs to capture fast-moving objects with high accuracy and minimal motion blur, making them ideal for applications such as robotics, autonomous vehicles, and sports analysis. The EVSs may be included an event camera. The CISs may be included in a frame-based camera.

Another significant advantage of EVSs is their ability to provide temporally dense information. Traditional CISs capture a series of frames at a fixed rate, which may result in missing important details between frames. In contrast, EVSs capture every single change in the scene, providing a continuous stream of information with microsecond-level temporal resolution. This enables EVSs to capture fast and subtle movements that would be missed by CISs that capture images at a fixed rate, making them suitable for applications such as object tracking, gesture recognition, and motion analysis. EVSs also excel in capturing scenes with high dynamic range. Traditional CISs struggle to capture scenes with extreme variations in lighting conditions, often resulting in overexposed or underexposed areas. EVSs, on the other hand, have a high dynamic range, allowing them to capture details in both bright and dark areas simultaneously. This makes EVSs ideal for applications such as surveillance, outdoor imaging, and HDR imaging. Furthermore, EVSs offer the advantage of low power consumption. Since they only capture and transmit data when there is a change in the scene, EVSs require significantly less power compared to traditional CISs that continuously capture frames. This makes event cameras suitable for battery-powered devices and applications where power efficiency is crucial. In conclusion, EVSs, are a groundbreaking technology that offers several advantages over traditional CISs. Their ability to capture asynchronous images, provide temporally dense information, eliminate image blur, and offer high dynamic range makes them highly desirable in various fields such as robotics, autonomous vehicles, surveillance, and more. With their unique capabilities, EVSs are poised to revolutionize the way we capture and process visual information in the future.

Hybrid image sensors utilize an array of pixels that comprises a combination of (i) CIS pixels, which are employed to capture CIS information corresponding to light from an external scene, and (ii) EVS pixels, which are utilized to obtain non-CIS information pertaining to light from the same external scene. Consequently, such hybrid image sensors are capable of simultaneously capturing (a) intensity images or video of the external scene and (b) events occurring within that scene.

The combination of CISs and EVSs offers several advantages. For example, it enables high-speed video reconstruction. CISs capture frames at a fixed rate. However, EVSs only capture changes in the scene, resulting in a sparse representation of the visual information. By combining the two, it is possible to reconstruct high-speed videos by filling in the gaps between the CIS frames with EVS data. This allows for the capture of fast-moving objects and actions that would otherwise be missed by traditional CISs alone.

Another advantage is motion blur reduction. CIS frames may suffer from motion blur when capturing fast-moving objects within an integration time interval of each image frame where the position of fast-moving object vary between the start and end of the integration time. On the other hand, EVSs capture events with high temporal resolution, resulting in less motion blur. By combining the two sensors, it is possible to reduce motion blur in the final image or video, resulting in sharper and more detailed visuals.

Furthermore, the combination of CIS and EVS data may allow for high dynamic range (HDR) imaging with no ghosting. High Dynamic Range (HDR) imaging involves capturing multiple exposures of a scene to capture both the bright and dark areas accurately. However, traditional HDR techniques can result in ghosting artifacts when objects move between exposures. EVSs, with their high temporal resolution, can capture events without any motion blur, allowing for frame deblurring and temporal alignment that will result in accurate HDR imaging without ghosting artifacts.

Methods for combining CISs and EVSs are compatible with applications with multiple cameras or applications with hybrid systems. For example, data of an EVS camera can be combined with data of a CIS camera to output combined image data. Additionally, CIS pixels and EVS pixels can be integrated on the same sensor (e.g., on a single chip) so as to form a hybrid image sensor. The CIS pixels and EVS pixels can be arranged in different patterns for the hybrid image sensor according to the requirements for intensities and events. The ratio of the CIS pixels and EVS pixels on the hybrid image sensor can also vary according to the requirements for intensities and events.

Hybrid image sensors, combining EVS pixels and CIS pixels, offer a range of advantages that make them highly desirable in the field of computer vision. Their ability to capture spatially and temporally dense images, eliminate motion blur, and provide high dynamic range imaging without ghosting make them ideal for a wide range of applications, including robotics, autonomous vehicles, and sports analysis. Hybrid image sensors can also provide easier object recognition and tracking.

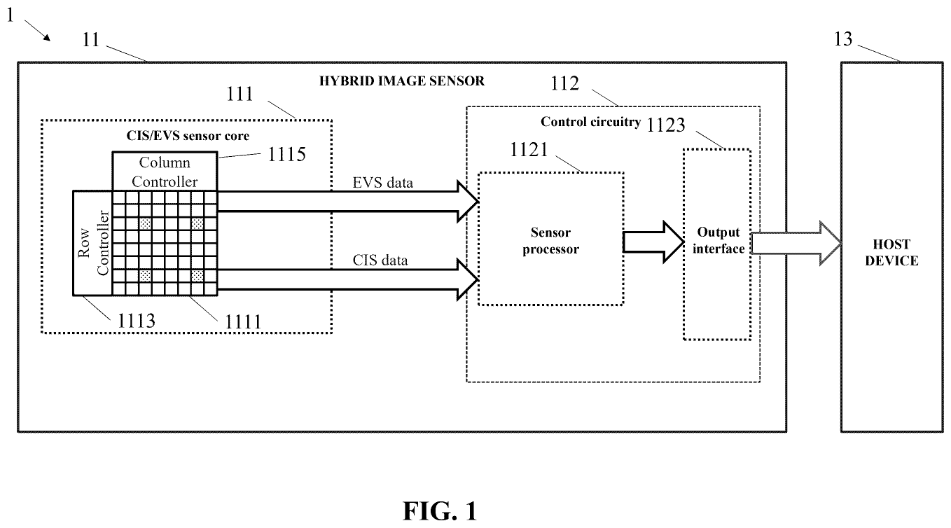

FIG. 1 illustrates a system diagram of an image system, in accordance with some embodiments of the present disclosure.

In some embodiments of the present disclosure, an image system 1 is shown in FIG. 1. In some embodiments of the present disclosure, the image system 1 includes a hybrid image sensor 11 and a host device 13. The host device 13 may be a computer for transferring image data for display, storage, or manipulation. The host device 13 may be a computing or application processor included in automobile, manufacturing machine, on-vehicle device, medic device, mobiles, and like. In some embodiments of the present disclosure, the hybrid image sensor 11 includes a CIS/EVS sensor core 111. The hybrid image sensor 11 may include control circuitry 112. The control circuitry 112 may include a sensor processor 1121. The control circuitry 112 may include an output interface 1123. The control circuitry 112 may couple to the CIS/EVS sensor core 111, and the control circuitry 112 may couple to the image array 1111. In some embodiments of the present disclosure, the CIS/EVS sensor core 111 includes an image array 1111, a row controller 1113 and a column controller 1115. In some embodiments of the present disclosure, the CIS/EVS sensor core 111 includes both CIS pixels configured for capturing CIS data corresponding to light from an external scene and EVS pixels configured for capturing EVS data, which is a non-CIS information pertaining to light from the same external scene such as occurrence of change in intensity or event. In some embodiments of the present disclosure, the row controller 1113 and the column controller 1115 control the rows and columns of the pixels in the image array 1111, respectively for imaging and readout operations. In some embodiments of the present disclosure, the EVS data and the CIS data outputted from the image array 1111 are transmitted to the sensor processor 1121. In some embodiments of the present disclosure, the processed results can be transmitted to the output interface 1123 so as to be further transmitted to the host device 13. In some embodiments of the present disclosure, the CIS/EVS sensor core 111 in FIG. 1 can be replaced with an EVS sensor core and a CIS sensor core including their own respective event-sensing array or image array.

In modern digital imaging systems, particularly those incorporating Complementary Metal-Oxide-Semiconductor (CMOS) image sensors (CIS), maintaining optimal image quality in dynamic environments presents significant challenges. Motion blur, caused by relative movement between an imaging device and a scene or object during image capture, remains a persistent issue. Such blur can severely degrade image fidelity, obscure fine details, and impede the performance of subsequent image processing operations, including but not limited to, object recognition, tracking, and measurement.

Various techniques have been developed in an attempt to address motion blur. For instance, Optical Image Stabilization (OIS) and Electronic Image Stabilization (EIS) mechanisms are commonly employed to counteract camera shake and stabilize the captured image. While these stabilization methods can be effective in reducing blur caused by camera movement, they often prove insufficient to completely eliminate blur induced by fast-moving subjects within the scene. Furthermore, EIS, being a digital post-processing technique, may inadvertently introduce undesirable digital artifacts or image distortion, particularly when applied to video footage.

Another approach involves increasing the ISO sensitivity of the image sensor. A higher ISO setting allows for shorter exposure times, which can inherently reduce the extent of motion blur. However, increasing ISO sensitivity typically leads to an increase in image noise, particularly noticeable in darker regions of the image, thereby compromising the overall signal-to-noise ratio and image quality.

Exposure fusion techniques, such as combining long and short exposure frames, have also been utilized to enhance dynamic range and reduce motion blur. The intent is to leverage the detail captured by longer exposures in static areas and the motion-freezing capability of shorter exposures. However, such fusion techniques in mobile photography contexts often entail substantial computational complexity, which can be challenging for real-time processing or for devices with limited computational resources. Moreover, improper blending of these frames can result in visual artifacts and unnatural transitions. Crucially, even with exposure fusion, subjects undergoing rapid motion may still exhibit residual blur.

Similarly, short-exposure stacking, which involves combining multiple short-exposed frames, aims to improve image quality by averaging out noise and reducing motion blur. While beneficial, this approach introduces its own set of practical limitations. These include increased processing overhead due to the need to acquire and combine multiple frames, the potential for artifacts arising from subject movement between sequential frames, greater storage space requirements for raw image data, and higher battery consumption. The inherent complexity for real-time capture scenarios can also affect its practicality and effectiveness in various shooting conditions.

More recently, AI-driven processing has emerged as a promising avenue for image enhancement, including deblurring. These methods typically rely on sophisticated algorithms and substantial computational resources, often involving deep learning models. While powerful, AI-driven solutions may not consistently produce desired results across all scenarios and may not always accurately predict user preferences or effectively generalize to novel blurring patterns.

A particularly noteworthy development is the single frame CIS+EVS fusion approach, which combines a traditional CMOS image sensor (CIS) with an Event Vision Sensor (EVS), also known as a neuromorphic camera. This novel approach leverages the asynchronous, event-driven nature of EVS, which captures changes in intensity with microsecond temporal resolution, along with the high-resolution, full-frame imaging capabilities of CIS sensors. This combined methodology offers the potential for real-time, high-quality image restoration with reduced motion blur. While this fusion can significantly improve image sharpness, a persistent challenge has been the difficulty in completely eliminating “ghosting” artifacts. These ghosting issues can arise due to factors such as EVS quantization errors and inherent latencies in the event stream, which can lead to misalignments or temporal discrepancies between the CIS frame and the corresponding event data.

Among the aforementioned existing solutions, multi-frame fusion techniques, such as “Long+Short” exposure fusion or “Multiple Short-Exposed Frames” stacking, have found widespread practical application. A critical prerequisite for the successful implementation of these multi-frame fusion methods is the accurate temporal alignment of frames captured at different points in time. This alignment process often necessitates solving for the motion flow of all pixels across the frames. However, the computation of such motion flow is generally a computationally intensive and time-consuming process, making it challenging to implement efficiently on-chip for real-time applications. Furthermore, accurate motion alignment becomes increasingly difficult or even impractical under conditions of very fast motion or when dealing with non-rigid objects that undergo complex deformations. These limitations underscore the need for improved systems and methods for image deblurring.

The techniques described in the present disclosure are not limited to improving the clarity of static images but are also broadly applicable to the enhancement of dynamic video sequences. Applying these deblurring methodologies to video data imposes more stringent requirements on computational efficiency and algorithmic runtime. In particular, the processing of continuous video streams requires algorithms capable of operating with exceptionally low latency to ensure seamless and responsive user experiences, an advantage distinctly offered d by the disclosed invention.

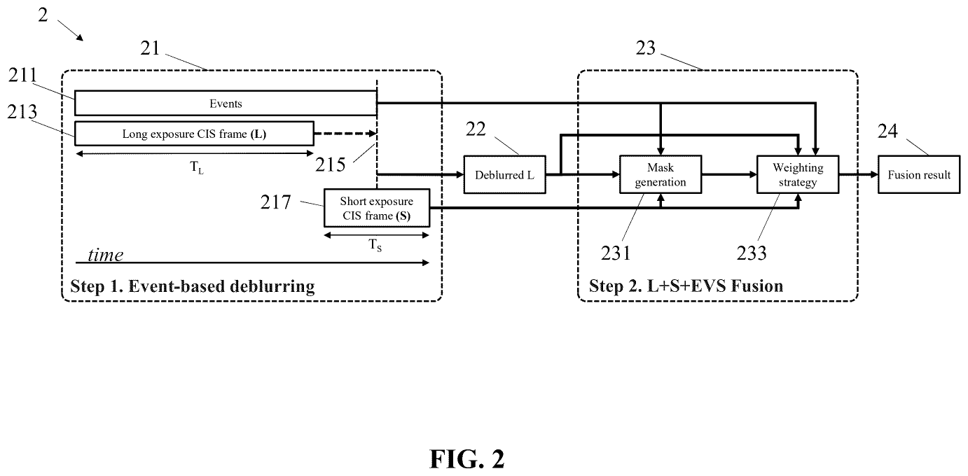

Referring to FIG. 2, an illustrative block diagram depicting an image deblurring process 2, in accordance with some embodiments of the present disclosure, is provided. The process 2 may be performed by a sensor processor (e.g., sensor processor 1121 in FIG. 1) included in a control circuitry of a hybrid image sensor (e.g., control circuitry 112 of hybrid image sensor 11 in FIG. 1) and coupled to receive EVS data and CIS data received from an image array included in a CIS/EVS sensor core (e.g., CIS/EVS sensor core 111 in FIG. 1), and the sensor processor (e.g. sensor processor 1121 in FIG. 1) has corresponding executable instructions stored thereon or in a memory unit. The process 2 comprises two main stages: Step 1, which is an event-based deblurring stage, and Step 2, which is an L+S+EVS fusion stage. This architecture advantageously leverages the high temporal resolution of EVS data with the high spatial resolution and intensity information of CIS frames to produce a deblurred, high-quality image.

Step 1: Event-based Deblurring stage (Block 21). In this initial stage, as shown in FIG. 2, Events 211 from an EVS and a Long exposure CIS frame (L) 213 are processed. In some embodiments of the present disclosure, Events 211 and the Long exposure CIS frame (L) 213 are captured by the CIS/EVS sensor core 111 in FIG. 1. The Long exposure CIS frame (L) 213, which captures substantial light information with long exposure having duration T_{L} for example, is typically susceptible to significant motion blur in dynamic scenes. The Events 211, conversely, provides sparse but temporally precise information about changes in intensity, effectively capturing motion without blur. In one embodiment of the present disclosure, the sensor processor 1121 of the image system 1 as shown in FIG. 1 sets a deblurring reference timestamp 215 such that the Long exposure CIS frame (L) 213 is deblurred to correspond temporally to the middle (or mid-time point) of the exposure period of a subsequent Short exposure CIS frame(S) 217, which captures substantial light information with short exposure having duration Ts for example. In some embodiments of the present disclosure, the Short exposure CIS frame(S) 217 are captured by the CIS/EVS sensor core 111 in FIG. 1. This temporal alignment is crucial for subsequent fusion. The processing in block 21 utilizes the Events 211 to effectively deblur the Long exposure frame (L) 213, thereby generating a deblurred long exposure CIS frame, Deblurred L 22. This Event-based Deblurring stage (Block 21) advantageously mitigates the blur present in the long exposure frame without relying on computationally intensive motion flow estimation from dense image frames, which is often challenging for fast and non-rigid motion.

Step 2: L+S+EVS Fusion stage (Block 23). Following the event-based deblurring of the long exposure frame, the second stage of the process involves fusing the Deblurred L frame 22 with the Short exposure CIS frame(S) 217 and the Events 211. The Short exposure CIS frame(S) 217 provides high-resolution intensity information with minimal motion blur, but may suffer from increased noise or underexposure, especially in low-light conditions. Block 23 integrates these distinct data streams to generate a final high-quality, deblurred image.

Within the L+S+EVS Fusion stage (Block 23), a Mask generation module 231 is configured to receive the Deblurred L frame 22, the Short exposure CIS frame(S) 217, and Events 211 from the event-based deblurring stage. The Mask generation module 231 generates fusion masks, which define regions within the image where different fusion strategies will be applied. Subsequently, a Weighting strategy module 233 also receives inputs from the Deblurred L frame 22, the Short exposure CIS frame(S) 217, and Events 211. The Weighting strategy module 233 is configured to determine fusion weights for different regions of the image. Both the fusion masks and the fusion weights are intelligently determined based on comprehensive motion analysis derived from the Events 211 and image frequency analysis performed on the Deblurred L frame 22 and the Short exposure CIS frame(S) 217. For example, regions exhibiting high motion (as indicated by event density) or high frequency content may be weighted more towards the short exposure frame (e.g., the Short exposure CIS frame(S) 217) or the deblurred long exposure frame (e.g., Deblurred L frame 22), depending on the specific characteristics and confidence levels. Conversely, static regions or areas with lower frequency content might predominantly utilize the deblurred long exposure frame (e.g., Deblurred L frame 22) for its superior signal-to-noise ratio.

A fusion result 24 is then generated as a combination of the Deblurred L frame 22 and the Short exposure CIS frame(S) 217, guided by the generated masks and determined weights. This selective fusion process overcomes the ghosting issues often encountered in prior single-frame CIS+EVS fusion approaches by providing a deblurred long exposure reference and intelligently blending it with a short exposure frame and fine-grained motion information from events. The present disclosure thus provides a robust and effective solution for image deblurring, yielding high-quality images with reduced motion blur and improved visual fidelity across various challenging imaging scenarios.

The proposed architecture, as illustrated in FIG. 2, offers significant advantages over known deblurring methodologies. By initially deblurring the long exposure CIS frame (L) 213 using high-temporal resolution events, the imaging system (e.g., imaging system 1 in FIG. 1) effectively addresses the motion blur limitations of traditional frame-based sensors while preserving spatial resolution and signal integrity.

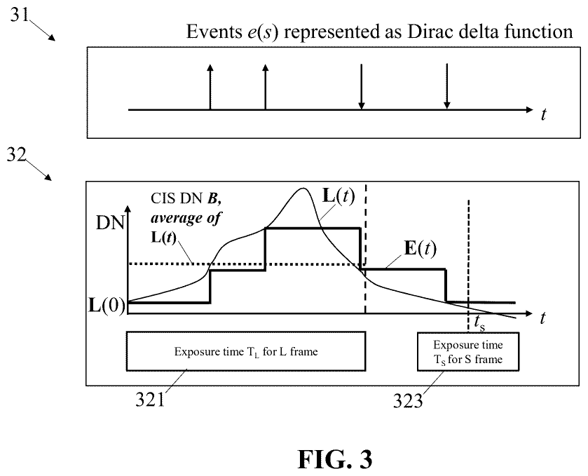

Turning now to FIG. 3, exemplary time diagrams illustrating the event flow and the pixel illuminance over time are provided, in accordance with some embodiments of the present disclosure. FIG. 3 specifically details the principles underlying Step 1: Event-based Deblurring (Block 21 in FIG. 2), which is a crucial component of the overall deblurring process described with respect to FIG. 2.

As depicted in the upper diagram 31 of FIG. 3, events e(s) detected by an event vision sensor are represented as Dirac delta functions occurring asynchronously at specific timestamps s. Each event signifies a change in logarithmic intensity at a pixel location. The lower diagram 32 of FIG. 3 illustrates the relationship between these events, the instantaneous pixel illuminance, and the integration of light by a CIS pixel. The diagram shows the instantaneous pixel value L(t), the blurry CIS image Digital Number B which is the average of L(t) over the exposure time, and the accumulated event value E(t). The exposure time T_{L} for the Long exposure CIS frame (L) 213 is indicated by 321, and the exposure time T_{S} for the Short exposure CIS frame(S) 217 is indicated by 323.

In this context, we consider a single pixel within the EVS array. Let B represent the blurry CIS image Digital Number (DN) captured during an exposure period from t=0 to t=T. The instantaneous logarithmic intensity change E(t) at a given timestamp t due to events is defined as the integral of event activations:

$$E ( t ) = {\int }_{0}^{t} e ( s ) ds .$$

Further, we denote L(t) as the latent image DN (deblurred DN) at the timestamp t. According to the EVS measuring principle, the instantaneous pixel value L(t) can be expressed relative to an initial latent image L(0) at t=0 by incorporating the accumulated logarithmic intensity changes due to events E(t):

$$L ( t ) = L ( 0 ) exp ( cE ( t ) ) = L ( 0 ) exp {( c )}^{E ( t )} .$$

where c is a constant related to the logarithmic response of the EVS pixels included in the CIS/EVS sensor core of the hybrid image sensor (e.g. CIS/EVS sensor core 111 of hybrid image sensor 11 in FIG. 1). This relationship highlights how the true, unblurred pixel value at any instant t is influenced by its initial value and the cumulative event activity up to that instant.

For a blurry image B, which is captured by a traditional CIS sensor over an exposure period [0, T], the measured Digital Number B is an average of the instantaneous latent pixel values L(t) over that exposure time. Therefore, the blurred image B can be represented as the integral of L(t) over the exposure time, scaled by the exposure duration T:

$$B = \frac{1}{T} {\int }_{0}^{T} L ( t ) dt$$

Substituting the expression for L(t) from above into the integral, we get:

$$B = \frac{1}{T} {\int }_{0}^{T} L ( t ) dt$$

$$= \frac{1}{T} {\int }_{0}^{T} L ( 0 ) exp ( cE ( E ) ) dt$$

$$= \frac{L ( 0 )}{T} {\int }_{0}^{T} exp ( c {\int }_{0}^{t} e ( s ) ds ) dt .$$

From this relationship, we can derive the equation to solve for the initial latent image L(0) based on the measured blurry image B and the event data E(t):

$$L ( 0 ) = \frac{BT}{Δ t {\sum }_{i = 0}^{N} exp ( cE ( t ) ) dt}$$

Once L(0) is determined, the deblurred latent image L(t) at any specific timestamp t within the exposure period can be calculated using the previously defined relationship:

$$L ( t ) = L ( 0 ) exp ( cE ( t ) )$$

In the context of the overall deblurring process shown in FIG. 2, t is set to tₛ, which is the deblurring reference timestamp 215 of the exposure period of Short exposure CIS frame(S) 217 (corresponding to the Exposure time T_{S} for S frame 323 in FIG. 3), thereby allowing for temporal alignment of the deblurred long exposure frame with the short exposure frame through this deblurring calculation. The exposure time T_{L} for the L frame is indicated by 321 in FIG. 3.

The above computation can be generalized to all pixels across the EVS array. By applying this principle to each pixel, a deblurred frame (e.g., Deblurred L frame 22 in FIG. 2) corresponding to the long exposure CIS frame is generated. This deblurring process is performed pixel-wise, effectively removing motion blur by leveraging the high temporal resolution of event data. In one or more embodiments, the above computation be programed via executable instruction for the sensor processor (e.g. sensor processor 1121 in FIG. 1) to access and executed when performing Event-based Deblurring stage illustrated in FIG. 2.

In accordance with various embodiments of the present disclosure, an imaging system is provided. Such an imaging system comprises a hybrid image sensor and control circuitry, configured to perform advanced image deblurring operations. As conceptually illustrated in figures, such as CIS/EVS sensor core 111 in FIG. 1, the hybrid image sensor (e.g. hybrid image sensor 11 in FIG. 1) is configured to include an event driven sensing array and a pixel array. In some embodiments of the present disclosure, the event-driven sensing array and the pixel array may be interwoven to form a single image array (e.g., image array 1111 in FIG. 1). Referring to FIG. 1, the blocks with a dotted background represent the event-driven sensing array, while the white blocks represent the pixel array. Together, the event-driven sensing array and the pixel array form the complete image array of the hybrid image sensor (e.g. hybrid image sensor 11 in FIG. 1). The event driven sensing array includes a plurality of event vision sensor (EVS) pixels arranged in EVS pixel rows. One of these EVS pixels is specifically configured to capture first EVS data, which corresponds to contrast information of light incident on that EVS pixel within a first time interval. Concurrently, the pixel array includes a plurality of CMOS image sensor (CIS) pixels arranged in CIS pixel rows. One of these CIS pixels is configured to capture first CIS data corresponding to the intensity of light incident on the CIS pixel within a second time interval, and to capture second CIS data corresponding to the intensity of light incident on the CIS pixel within a third time interval. In various embodiments, the second time interval precedes the third time interval. The first CIS data is typically associated with a longer exposure (e.g., as the long exposure L frame 213 in FIG. 2) and the second CIS data with a shorter exposure (e.g., as the short exposure S frame 217 in FIG. 2) that follows. In some embodiments, the first time interval (for EVS data) is longer than the second time interval (for first CIS data), ensuring sufficient event information for deblurring. Furthermore, in certain embodiments, the second time interval (for first CIS data) is longer than the third time interval (for second CIS data), aligning with common long-short exposure configurations. The event driven sensing array and the pixel array of the image array may couple to the control circuitry 112 so that the control circuitry 112 may receive EVS data and the CIS data.

As depicted in FIG. 1, the imaging system 1 comprises control circuitry 112. In some embodiments of the present disclosure, the control circuitry 112 comprises the sensor processor (e.g., sensor processor 1121 in FIG. 1). In some embodiments, the control circuitry 112 constitutes a portion of the sensor processor 1121, which may include other components. Additionally, in some embodiments, the control circuitry 112 includes the sensor processor 1121 together with other components (such as memory units). In some embodiments, the control circuitry 112 includes the sensor processor 1121 may be internal or external to the hybrid image sensor 11.

The control circuitry (e.g. control circuitry 112 in FIG. 1) is configured to perform a plurality of operations to achieve image deblurring, as generally depicted in figures such as FIG. 2. The control circuitry (e.g. control circuitry 112 in FIG. 1) may use instructions to perform the plurality of operations. These instructions may be stored either internally within the control circuitry (e.g. control circuitry 112 in FIG. 1) or externally.

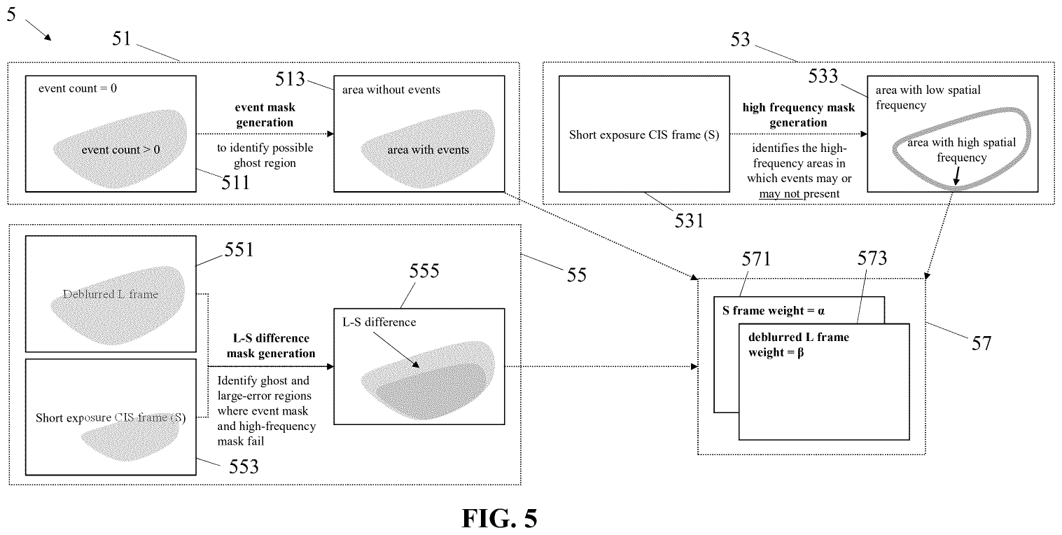

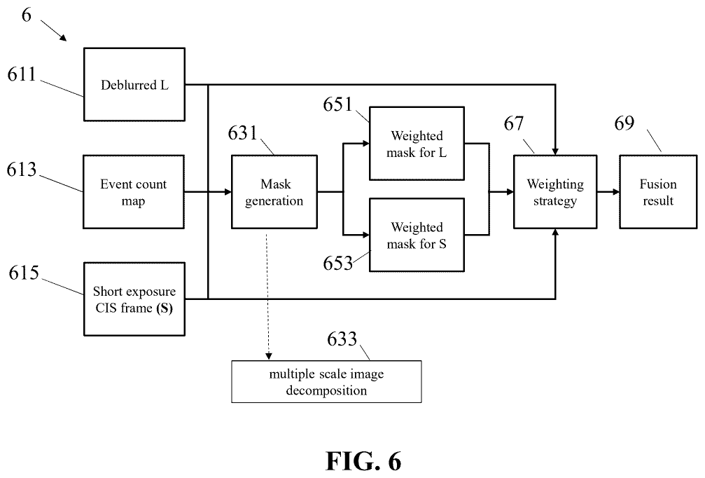

These operations include, but are not limited to:
Using the first EVS data to deblur the first CIS data. This operation corresponds to the “Event-based deblurring” Step 1 (e.g., block 21 in FIG. 2), where the precise temporal information from events (e.g., Events 211 in FIG. 2, block 31 in FIG. 3) is leveraged to remove motion blur from the longer exposure CIS frame (e.g., Long exposure CIS frame (L) 213 in FIG. 2). This deblurred long exposure frame is designated as Deblurred L frame (e.g., Deblurred L frame 22 in FIG. 2).
Generating fusion masks and fusion weights based on at least one of the first EVS data, the first CIS data, and the second CIS data. This operation relates to the “Mask generation” (e.g., Mask generation module 231 in FIG. 2) and “Weighting strategy” (e.g., Weighting strategy module 233 in FIG. 2) discussed in detail with respect to FIGS. 5 and 6. The fusion masks and weights are adaptively determined based on various image characteristics and motion information derived from these data sources.
Fusing the deblurred first CIS data and the second CIS data with the generated fusion masks and fusion weights. This is the core fusion step Step 2 (e.g., block 23 in FIG. 2), where the deblurred longer exposure frame (e.g., Deblurred L frame 22 in FIG. 2) and the short exposure frame (e.g., short exposure CIS frame(S) 217 in FIG. 2) are combined to yield a high-quality deblurred image (e.g., Fusion result 24 in FIG. 2).

For on-chip implementation, where continuous integration may not be feasible, summation can be utilized to approximate the integral. The total exposure time T in embodiments can be segmented into N small intervals, each with a duration of

$$Δ t = \frac{T}{N} ,$$

the calculation for L(0) can be expressed in a discrete form:

$$L ( 0 ) = \frac{BT}{Δ t {\sum }_{i = 0}^{N} exp ( {cE}_{i} )}$$

where Eᵢ denotes the accumulated events during the i-th interval. For the general on-chip version of the deblurring algorithm, where f denotes a discrete temporal index of tₛ, the deblurred latent image L(f) can be expressed as:

$$L ( f ) = L ( 0 ) exp ( {cE}_{f} )$$

In hardware implementations, an offset buffer may be configured to store Ef values, and an accumulation buffer may be configured to store the summation term

$${\sum }_{i = 0}^{N} exp ( {cE}_{i} ) .$$

Furthermore, to facilitate efficient processing in the logarithmic domain, especially if multiple logarithmic and exponential operations are supported, the deblurring can be implemented using log domain operations. The logarithmic form of the deblurred latent image log {L(f)} can be derived as:

$$log \{ L ( f ) \} = log \{ B \} - log \{ \frac{Δ t}{T} {\sum }_{i = 0}^{N} exp ( {cE}_{i} ) \} + cE ( f )$$

And then converted back to a linear domain to obtain L(f) using an exponential function:

$$L ( f ) = exp [ log \{ L ( f ) \} ] .$$

This on-chip implementation provides a computationally efficient mechanism for performing the event-based deblurring, making it suitable for real-time applications within integrated circuit environments.

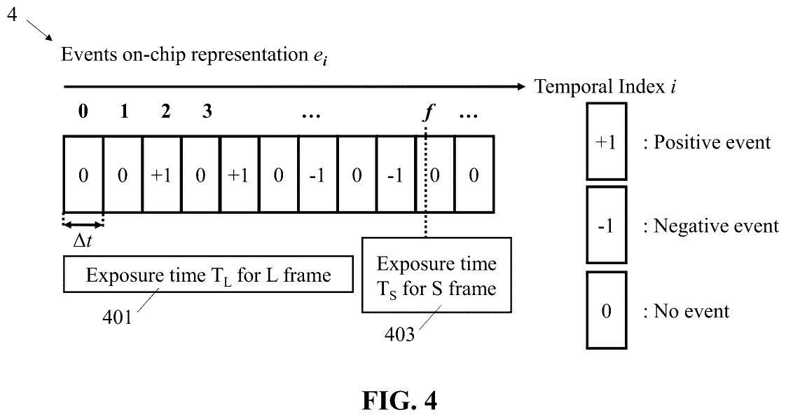

To further elaborate on the on-chip implementation 4 of the event-based deblurring, reference is now made to FIG. 4, which illustrates a temporal representation of events suitable for hardware processing, in accordance with some embodiments of the present disclosure. The on-chip implementation 4 may be realized by control circuitry (e.g., control circuitry 112 in FIG. 1) having corresponding executable instructions stored thereon or in a memory unit. FIG. 4 depicts the “Events on-chip representation eᵢ” along a temporal index i. Each discrete time interval, denoted by Δt, corresponds to a unit on the temporal index i. This discretized representation allows for efficient processing of asynchronous event streams in a synchronous digital circuit.

As shown in FIG. 4, the value of eᵢ at each temporal index i can be one of three states: “+1” indicating a positive event (an increase in logarithmic intensity at the pixel), “−1” indicating a negative event (a decrease in logarithmic intensity at the pixel), or “0” indicating that no event occurred during that particular Δt interval. The exposure time for the long exposure L frame 401 and the exposure time for the short exposure S frame 403 are indicated within this temporal timeline, emphasizing their discrete nature in the on-chip processing environment. The imaging system can process events occurring throughout the exposure time T_{L} for L frame 401 and potentially into the exposure time T_{S} for S frame 403 to precisely determine the deblurring reference timestamp.

The on-chip implementation of the event-based deblurring algorithm described above can be further understood by referring to the pseudocode provided below.

```
On-chip algorithm pseudocode
i = 0, E = 0, A = 0 // E is offset buffer; A is accumulation buffer.
WHILE i < f:
  GET eᵢ FROM EVS
  E = E + eᵢ
  IF i < N:
    A = A + exp(cE)
  i++
GET CIS MEASUREMENT B
COMPUTE L(f) ACCORDING TO EQN.
```

This pseudocode outlines an exemplary process for computing the necessary values for L(f) according to equation for efficient on-chip execution.

The algorithm initializes a loop counter i to 0, an offset buffer E to 0, and an accumulation buffer A to 0. The offset buffer E is configured to store the accumulated event values (e.g., cE, or E before scaling by c), and the accumulation buffer A is configured to store the summation term Σexp(cE), as previously described. The algorithm proceeds in a loop, iterating as long as the current temporal index i is less than f, where f represents the specific temporal index at which the deblurred image is to be calculated (e.g., the middle of the S frame exposure, as indicated in FIG. 2).

Within each iteration of the loop, at the current temporal interval i, the corresponding event representation eᵢ is retrieved from the EVS data stream. The offset buffer E is then updated by adding the retrieved er to its current value (E←E+eᵢ). This incrementally accumulates the events over time, reflecting the changing logarithmic intensity. If the current temporal index i is less than N (where N corresponds to the total number of Δt intervals for the full long exposure time T), the accumulation buffer A is updated by adding the exponential of the current accumulated event value (A←A+exp(E)). The loop counter i is then incremented. This process effectively computes the denominator of the equation for L(0) (as presented above) in a discrete, incremental manner. It is noted that the pseudocode provided for illustration primarily considers scenarios where the calculation point of the deblurred image is beyond the exposure time T of the L frame (i.e., f>N), which aligns with setting the deblurring reference timestamp to the middle of the S frame exposure, thus accounting for events across both relevant exposure windows.

Once the loop completes (i.e., when i reaches f), the CIS measurement B (representing pixel value in the blurry long exposure CIS frame) is obtained. Subsequently, the deblurred latent image L(f) is computed according to the equation derived previously, utilizing the accumulated values from the offset buffer E and the accumulation buffer A. This on-chip implementation provides a computationally efficient mechanism for performing the event-based deblurring, making it suitable for real-time applications within integrated circuit environments.

The mask generation and fusion weighting process 5 of the L+S+EVS Fusion (Step 2, Block 23 in FIG. 2) is further elucidated in FIG. 5, which illustrates the operations of different mask generations and their subsequent use in determining fusion weights, in accordance with some embodiments of the present disclosure. The process 5 may be performed by control circuitry (e.g., control circuitry 112 in FIG. 1) having corresponding executable instructions stored thereon or in a memory unit. As shown in FIG. 5, the process 5 involves three primary mask generation sub-modules 51, 53, 55 that provide inputs to a final weighting module 57.

The first sub-module is an Event Mask Generation module 51. This sub-module primarily analyzes the event data (e.g., 211 from FIG. 2) to identify areas of motion within the scene. It takes the event count for various regions as input. If the event count for a given region is zero (“event count=0”), it indicates a static area or a region with no discernible motion. If the event count is greater than zero (“event count>0”), it signifies an area with motion. The event mask generation unit 511 processes these event counts to identify possible “ghost regions,” which are typically associated with significant motion that could lead to artifacts if not handled properly. The output of this sub-module 513 logically segregates the image into an “area without events” (likely static) and an “area with events” (likely dynamic). In some embodiments of the present disclosure, alternative event mask generation logic may be employed by incorporating mean filters, median filters, erosion filters, or dilation filters on top of the event count maps. Additionally, event polarity may be utilized for event counting, i.e., by accumulating events with their respective signs according to their polarities.

Concurrently, a High Frequency Mask Generation module 53 processes the Short exposure CIS frame(S) 531 (e.g., 217 from FIG. 2). This module takes the Short exposure CIS frame(S) 531 as its input and performs high-frequency analysis 533. This analysis identifies areas with high spatial frequency content (i.e., sharp details and textures, labeled as “area with high spatial frequency”) and areas with low spatial frequency content (i.e., smooth or blurred regions, labeled as “area with low spatial frequency”). The high-frequency analysis is particularly useful for identifying sharp edges and fine details where the S frame might offer superior clarity due to its intrinsically short exposure, regardless of whether events are present or not.

Furthermore, an L-S Difference Mask Generation module 55 is utilized to detect discrepancies and potential errors between the Deblurred L frame 22 and the Short exposure CIS frame(S) 217. This module takes a Deblurred L frame 551 and a Short exposure CIS frame(S) 553 as inputs. The L-S difference mask generation unit 555 computes the difference between these two frames. This computed difference map (indicated as “L-S difference”) is crucial for identifying ghost and large-error regions that might not be reliably detected by the event mask (from module 51) or the high-frequency mask (from module 53) alone. Such regions often represent areas where the deblurring of the deblurred L frame 551 or the inherent sharpness of the short exposure CIS frame(S) 553 might be compromised, necessitating a more robust and adaptive fusion approach.

The outputs from the Event Mask Generation module 51, the High Frequency Mask Generation module 53, and the L-S Difference Mask Generation module 55 are all fed into a final Fusion Weight Assignment module 57. This module (which corresponds to the Weighting strategy 233 in FIG. 2) intelligently combines the information from these various masks to determine the optimal fusion weights for each pixel or region. Specifically, the module assigns a weight α to the S frame 571 and a weight β to the deblurred L frame 573. The values of α and β are adaptively determined such that α+β=1 (or a similar weighting scheme) to create a combined output. For example, in areas identified as high motion by the event mask 513 and/or areas with robust high spatial frequency by the high-frequency mask 533, and with significant difference errors, a higher weight α may be assigned to the S frame. Conversely, in static or low-motion areas, or areas where the Deblurred L frame 22 provides superior detail and lower noise, a higher weight β may be assigned to the Deblurred L frame 22. The L-S difference mask 555 particularly aids in identifying regions where neither the Deblurred L frame 22 nor the Short exposure CIS frame(S) 217 might be perfectly reliable, prompting a more cautious or blended weighting.

This multi-layered mask generation and adaptive weighting strategy ensures that the final fusion result (e.g., Fusion result 24 in FIG. 2) capitalizes on the strengths of each input source—the noise characteristics of the long exposure, the deblurred clarity from event integration, and the motion-freezing capability of the short exposure—while robustly mitigating ghosting and other artifacts, thereby producing a high-quality deblurred image.

Turning now to FIG. 6, a block diagram illustrating a process 6 including mask generation and weighting strategy for fusion is provided, in accordance with some embodiments of the present disclosure. FIG. 6 provides a more detailed architectural view of Step 2: L+S+EVS Fusion (corresponding to Block 23 in FIG. 2), specifically detailing the operation of the mask generation and the subsequent weighting strategy for combining the deblurred long exposure frame and the short exposure frame. The process 6 may be performed by control circuitry (e.g., control circuitry 112 in FIG. 1) having corresponding executable instructions stored thereon or in a memory unit.

The process 6 for L+S+EVS fusion receives several key inputs. These include a Deblurred L frame 611, which is the output of the event-based deblurring process (e.g., Deblurred L frame 22 in FIG. 2 from Block 21). Additionally, an Event count map 613 is provided, conveying pixel-wise information regarding motion activity derived from the EVS data. A Short exposure CIS frame(S) 615 is also inputted, offering inherently sharper details in dynamic regions due to its brief exposure time.

A Mask generation module 631 is configured to receive the Deblurred L frame 611, the Event count map 613, and the Short exposure CIS frame(S) 615. The Mask generation module 631 may employ pyramidal image decomposition techniques. In typical image fusion schemes, prior information such as contrast, saturation, and well-exposedness is commonly utilized to adjust weighting matrices to achieve optimal blending. These same criteria can be advantageously applied by the Mask generation module 631 to both the Deblurred L frame 611 and the Short exposure CIS frame(S) 615 to assess their respective quality characteristics across different image regions. Furthermore, the Event count map 613 is explicitly utilized by the Mask generation module 631 to indicate possible “ghost areas.” This is based on the understanding that ghost regions, which are undesirable artifacts caused by imperfect deblurring or misalignment, are always a subset of areas identified by significant event activity. The mask generation process is thus robustly informed by both image content quality and precise motion information.

Following the mask generation process within module 631, the system generates a Weighted mask for L 651 and a Weighted mask for S 653. These weighted masks are derived from the outputs of the Mask Generation module 631 and are configured to dictate the spatial and intensity contributions of each respective frame (e.g., Deblurred L 611 and the Short exposure CIS frame(S) 615) to the final fusion result.

The generated weighted masks 651 and 653, along with the Deblurred L frame 611 and the Short exposure CIS frame(S) 615, are then fed into a Weighting strategy module 67. This module implements the core fusion framework, which is based on a pixel-wise weighted average of the two motion-aligned frames (e.g., Deblurred L 611 and the Short exposure CIS frame(S) 615). In some embodiments of the present disclosure, alternative methods of image fusion may be employed, and denoising or smoothing operations may be utilized to facilitate fusion with reduced artifacts. Advantageously, to directly address the common problem of “seaming artifacts” that can arise when blending different image regions with varying characteristics or at different scales, the Weighting strategy module 67 may employ pyramidal image decomposition techniques. This technique enables seamless blending across various frequency bands of the image, thereby producing a more natural and artifact-free composite image.

The output of the Weighting strategy module 67 is the final Fusion result 69, representing a deblurred, high-quality image that effectively combines the best attributes of the long exposure, short exposure, and event data.

In specific embodiments, the generation of the fusion masks (e.g., within module 631 in FIG. 6, or sub-modules 51, 53, 55 in FIG. 5) can involve various analytical processes to identify relevant image regions. For instance, generating the fusion masks may include identifying a possible ghost region by analyzing the first EVS data, as detailed in FIG. 5 (sub-module 51). This leverages the event activity (e.g., event count>0) to pinpoint areas prone to ghosting artifacts due to motion. Additionally, generating the fusion masks can include identifying a high spatial frequency region by analyzing the second CIS data (e.g., Short exposure CIS frame(S) 217 in FIG. 2), as shown in FIG. 5 (sub-module 53). This allows the system to prioritize regions in the short exposure frame that inherently possess sharp details. Furthermore, the generation of fusion masks may involve identifying ghost and large-error regions by comprehensively analyzing the first EVS data (e.g., Events 211 in FIG. 2), the first CIS data (e.g., Long exposure CIS frame (L) 213 in FIG. 2), and the second CIS data (e.g., Short exposure CIS frame(S) 217 in FIG. 2), as depicted by the L-S Difference Mask Generation (sub-module 55) in FIG. 5, thereby ensuring robustness in complex scenarios where other masks might fail. The control circuitry (e.g. control circuitry 112 in FIG. 1) is also configured such that generating the fusion weights (e.g., within module 67 in FIG. 6, or module 57 in FIG. 5) includes determining a pixel-wise fusion weight (e.g., S frame weight α (571) and deblurred L frame weight β (573)) based on these intelligently derived fusion masks.

To further enhance the quality and seamlessness of the final fused image, in some embodiments, the operation of fusing the deblurred first CIS data and the second CIS data includes using a pyramidal image decomposition. This technique, as referenced by Mask generation (631) and Weighting strategy (67) in FIG. 6, effectively mitigates seaming artifacts by blending image content across multiple scales, resulting in a more visually pleasing and coherent output. These artifacts manifest as visible discontinuities, such as abrupt changes in brightness, color, or texture, within the overlap regions of stitched images. Such discrepancies often arise from varying illumination conditions, exposure settings, parallax, or slight misalignments between captured frames. To effectively mitigate these seaming artifacts, a multiple scale image decomposition 633 intrinsically linked to pyramid mask generation may be employed. Image decomposition separates an input image into a plurality of frequency bands, each representing visual information at a distinct spatial scale. Specifically, a low-frequency base layer captures broad intensity variations and global illumination, while high-frequency detail layers encapsulate fine textures, edges, and localized variations. A pyramid mask provides a weight map that varies smoothly across the image, dictating the contribution of each source image pixel in the overlap region at each corresponding pyramid level.

Specifically, at the coarse (low-frequency) levels of the image pyramid, the blending mask can be designed to transition more gradually, thereby smoothing out large-scale photometric inconsistencies and mitigating visible illumination differences across stitched boundaries. This allows for a robust blending of the base layers, where the most noticeable seaming artifacts typically reside due to global variations. Concurrently, at the finer (high-frequency) levels, the pyramid mask enables more localized and detail-preserving blending. This ensures that sharp edges and intricate textures from the source images are accurately preserved and seamlessly transitioned, preventing blurring or artifact introduction that could arise from aggressive smoothing at these scales. The multi-scale decomposition, in conjunction with pyramid masks, thus facilitates a spatially and spectrally adaptive blending process, ensuring that the resulting composite image exhibits superior visual continuity and effectively eliminates discernible seaming artifacts.

Pyramid image decomposition is a well-established technique in image processing that involves representing an image at multiple resolutions or scales. Typically, this method constructs a hierarchical structure, known as an image pyramid, where each successive level contains a progressively lower resolution version of the original image. Common forms of pyramid decomposition include Gaussian pyramids and Laplacian pyramids. In a Gaussian pyramid, each level is generated by applying a low-pass filter followed by downsampling, effectively smoothing and reducing the image size. The Laplacian pyramid, on the other hand, captures the difference between adjacent Gaussian levels, thereby isolating band-pass frequency components. Pyramid image decomposition facilitates various applications such as image compression, enhancement, blending, and multi-scale analysis by enabling efficient processing and representation of image details across different spatial frequencies.

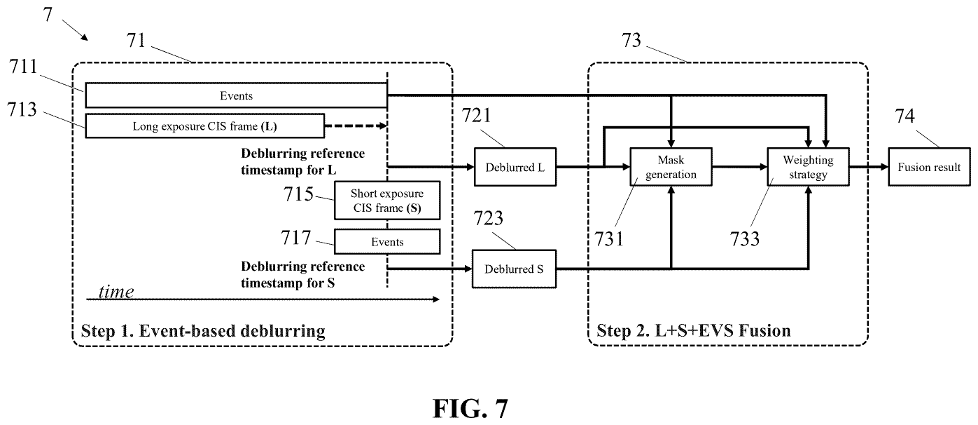

Referring now to FIG. 7, another image deblurring process 7 is illustrated, in accordance with some embodiments of the present disclosure. FIG. 7 conceptually presents a broader view of the L+S+EVS fusion principle, building upon the specific modules and steps previously detailed in FIGS. 2-6. The process 7 may be performed by control circuitry (e.g., control circuitry 112 in FIG. 1) having corresponding executable instructions stored thereon or in a memory unit. The process 7 fundamentally involves acquiring Events 711, a long exposure CIS frame (L) 713, and a short exposure CIS frame(S) 715.

Step 1: Event-based deblurring stage (Block 71). As previously described, this initial step focuses on leveraging the high-temporal resolution events 711 from event sensor pixels to deblur the Long exposure CIS frame (L) 713, resulting in a Deblurred L frame 721. It is important to note that, in practical implementations of Step 1, the exact values stored in various internal buffers (such as the offset and accumulation buffers discussed above) can differ. Various buffer allocations and management schemes can be designed and employed, as long as the mathematical integrity and correctness of the final deblurring results are obtained. This flexibility allows for optimized hardware design and resource utilization depending on specific application requirements and platform constraints.

Furthermore, in some advanced embodiments of Step 1, it is also possible to deblur the Short exposure CIS frame(S) 715 from CIS sensor pixel for examples included in a CIS/EVS sensor core of a hybrid image sensor (e.g., hybrid image sensor 11 in FIG. 1) in addition to the long exposure CIS frame (L) 713 by leveraging the high-temporal resolution Events 717 to deblur the short exposure CIS frame(S) 715 from CIS sensor pixels. This optional processing for the short exposure frame would generate a Deblurred S frame 723. The rationale for deblurring the Short exposure CIS frame(S) 715 is to further enhance its sharpness, particularly in scenarios where the Short exposure CIS frame(S) 715's exposure time, while relatively short, may still not be short enough to capture a completely clear scene under extremely fast or severe motion. In such cases, applying event-based deblurring principles to the Short exposure CIS frame(S) 715 can yield additional benefits by mitigating any residual blur present in the short exposure.

Step 2: L+S+EVS Fusion stage (Block 73). Within the L+S+EVS Fusion stage (Block 73), a mask generation module 731 and a weighting strategy module 733 are configured to receive the Deblurred L frame 721, the Deblurred S frame 723, and Events 711. This L+S+EVS Fusion stage performs the intelligent fusion, leveraging the mask generation and weighting strategies detailed in FIGS. 5 and 6, to produce the final Fusion result 74. The ability to selectively deblur and then combine both Deblurred L and S frames ensures that the system can adapt to a wide range of motion conditions, providing an optimal deblurred output that leverages the strengths of all available sensor data.

In an advantageous embodiment, as illustrated in FIG. 7, the hybrid image sensor (e.g., hybrid image sensor 11 in FIG. 1) is further configured such that one of the plurality of EVS pixels captures second EVS data corresponding to contrast information of light incident on that EVS pixel within the third time interval (e.g., events synchronized with the Short exposure CIS frame(S) 715). In such a configuration, the control circuitry (e.g. control circuitry 112 in FIG. 1) is configured to receive EVS data from EVS pixel and CIS data from CIS pixels and perform an additional operation before fusing the deblurred first CIS data and the second CIS data. This additional operation comprises using the second EVS data (e.g., Events 717 in FIG. 7) to deblur the second CIS data (e.g., as part of 723 in FIG. 7, leading to a Deblurred S frame). Subsequently, instead of using the original second CIS data, the system fuses the deblurred first CIS data (e.g., Deblurred L frame 721) and the deblurred second CIS data (e.g., Deblurred S frame 723) with the generated fusion masks and fusion weights (e.g., within 731 and 733 in FIG. 7). In some embodiments of the present disclosure, the fusion masks and fusion weights are generated at least partially based on the second EVS data (e.g., Events 717). This enhancement allows for further improvement in sharpness for the short exposure frame, particularly under extremely fast motion conditions where the short exposure alone may not be perfectly clear.

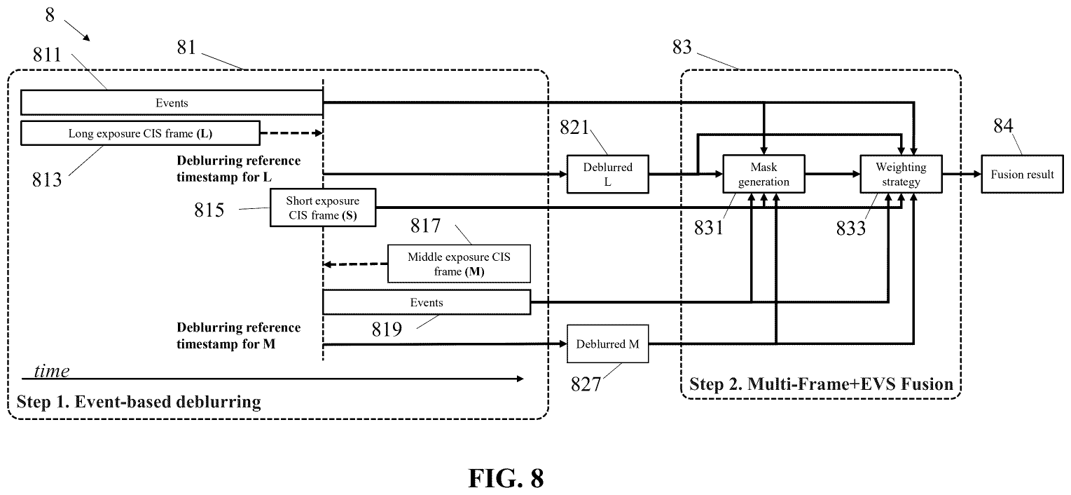

Referring now to FIG. 8, another image deblurring process 8 is illustrated, in accordance with some embodiments of the present disclosure. FIG. 8 presents an extended embodiment of the deblurring framework, demonstrating the flexibility of the disclosed system to incorporate additional frames for fusion, thereby enhancing performance across a wider range of imaging conditions and motion scenarios. The process 8 may be performed by control circuitry (e.g., control circuitry 112 in FIG. 1) having corresponding executable instructions stored thereon or in a memory unit.

In this embodiment, the system 8 receives Events 811 and, distinct from prior embodiments that focused on two CIS frames, acquires multiple CIS frames with varying exposure times. Specifically, an example of a “3-frame fusion” is shown, which includes a long exposure CIS frame (L) 813, a Middle exposure CIS frame (M) 817, and a Short exposure CIS frame(S) 815. This multi-exposure configuration can be generalized to any number of frames with different exposure settings.

Step 1: Event-based Deblurring stage (Block 81). In this enhanced Step 1, the Event-based deblurring stage (Block 81) is applied to each of the acquired CIS frames—the Long exposure CIS frame (L) 813, the Middle exposure CIS frame (M) 817, and the Short exposure CIS frame(S) 815. This stage utilizes the high-temporal resolution Events 811 to deblur the Long exposure CIS frame (L) 813, and utilizes the high-temporal resolution Events 819 to deblur the Middle exposure CIS frame (M) 817. Consequently, this step yields a Deblurred L frame 821, the Short exposure CIS frame(S) 815 and a Deblurred M frame 827. As previously discussed in relation to single-frame deblurring, the deblurring process aims to recover the latent, unblurred image content for each exposure duration, effectively correcting for motion blur using event information.

The use of more frames for fusion, such as this 3-frame (L+M+S) configuration, significantly increases the flexibility and robustness of the deblurring system. This multi-exposure configuration allows the system to adapt more effectively under various illumination conditions and motion speeds. For instance, in low-light conditions or for static background elements, the Deblurred L frame 821 can provide a high signal-to-noise ratio and rich detail. The Deblurred M frame 827 can provide an optimal balance for intermediate motion scenarios or serve as a bridge between the long and short exposures. This graduated set of deblurred frames provides richer and more versatile information to the subsequent fusion stage.

Step 2: Multi-frame+EVS Fusion stage (Block 83). The frames (Deblurred L frame 821, Short exposure CIS frame(S) 815 and Deblurred M frame 827), along with the Events 811 and Events 819, are then fed into a Multi-frame EVS Fusion stage (Block 83). This stage extends the intelligent mask generation and weighting strategies (as conceptually detailed in FIGS. 5 and 6) to handle three or more input frames. In some embodiments of the present disclosure, the fusion masks and fusion weights are generated at least partially based on the Events 819 and/or the middle exposure CIS frame (M) 817. The fusion algorithm can adaptively select or blend information from the most appropriate deblurred frame (L, M, or S) for each pixel or region based on local motion characteristics, illumination, and frequency content, thereby producing a highly robust and high-quality final Fusion result 84. This multi-frame approach further enhances the ability of the system to achieve superior image deblurring across a broad spectrum of real-world imaging challenges by providing more robust data inputs for the fusion process.

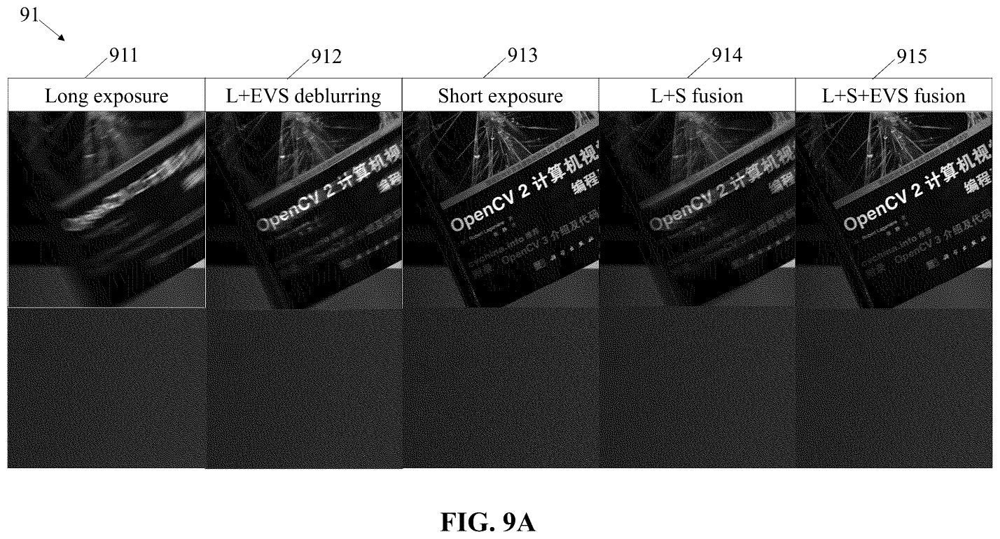

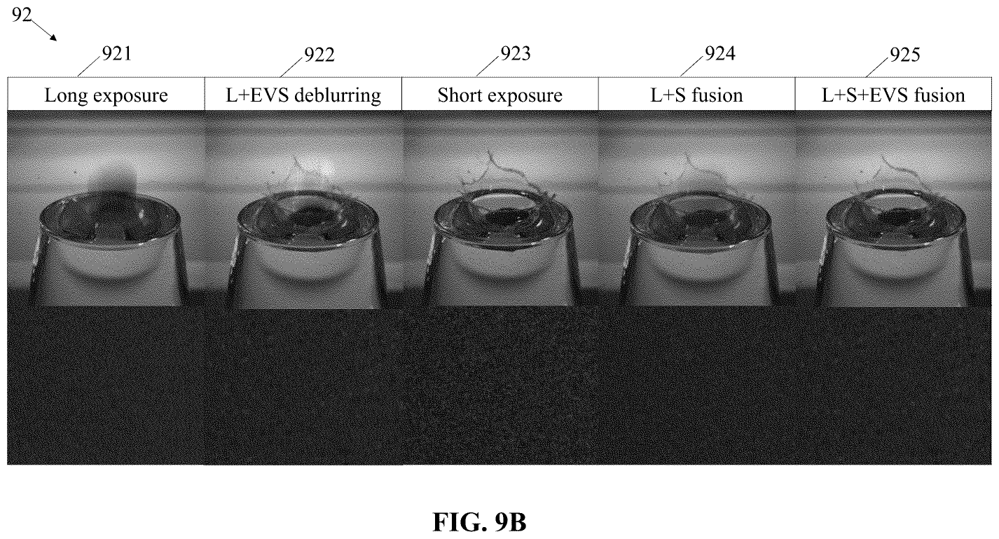

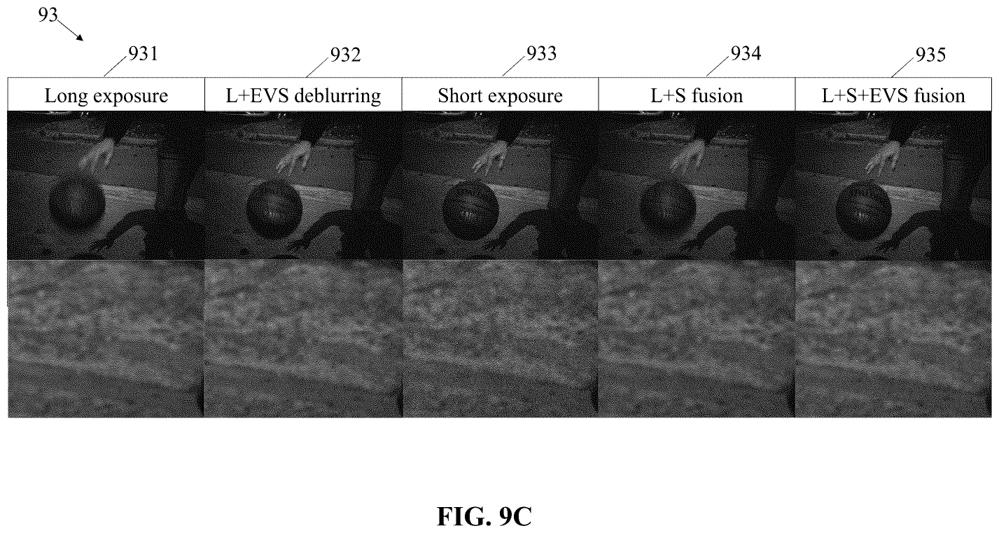

Referring now to FIGS. 9A-9C, comparative results of different deblurring techniques are illustrated, in accordance with some embodiments of the present disclosure. These figures demonstrate the advantageous performance of the disclosed L+S+EVS fusion technique compared to various conventional and hybrid deblurring methods under different scene conditions. The compared techniques include “Long exposure,” “L+EVS deblurring,” “Short exposure,” “L+S fusion,” and the presently disclosed “L+S+EVS fusion.” Each sub-FIG. 9A, 9B, 9C) presents image quality (sharpness/blurriness and ghosting) and noise level descriptions for each technique.

FIG. 9A: Comparative results for a book scene. As shown in comparative results 91 of FIG. 9A, which depict a book image, the results for various deblurring techniques are as follows:
The Long exposure result 911 exhibits significant blur and maintains the lowest noise level.”
The L+EVS deblurring result 912 shows an image that is less blurry but with ghosts, and has a low noise level.
The Short exposure result 913 is sharp but suffers from a high noise level.
The L+S fusion result 914 is less blurry but with ghosts, and presents a mid noise level.”
The L+S+EVS fusion result 915, representing the disclosed invention, achieves a sharp image quality while maintaining a low noise level.

This illustrates that the disclosed L+S+EVS fusion effectively resolves motion blur without introducing significant noise or ghosting artifacts in complex textual scenes.

FIG. 9B: Comparative results for a waterdrop scene. As shown in comparative results 92 of FIG. 9B, which depict a waterdrop image, the results for various deblurring techniques are as follows:
The Long exposure result 921 is blurry and exhibits the lowest noise level.
The L+EVS deblurring result 922 is less blurry with ghosts and has a low noise level.
The Short exposure result 923 is sharp but presents a high noise level.
The L+S fusion result 924 is less blurry but with ghosts, and has a mid noise level.
The L+S+EVS fusion result 925, representing the disclosed invention, achieves a sharp image quality while maintaining a low noise level.

This demonstrates the superior ability of the disclosed technique to capture fast-moving elements, such as a waterdrop splash, with high clarity and low noise.

FIG. 9C: Comparative results for a basketball scene. As shown in comparative results 93 of FIG. 9C, which depict a basketball image, the results for various deblurring techniques are as follows:
The Long exposure result 931 is blurry and has the lowest noise level.
The L+EVS deblurring result 932 is less blurry but with ghosts, and has a low noise level.
The Short exposure result 933 is sharp but exhibits a high noise level.
The L+S fusion result 934 is less blurry but with ghosts, and has a mid noise level.
The L+S+EVS fusion result 935, representing the disclosed invention, achieves a sharp image quality while maintaining a low noise level.

This further confirms the effectiveness of the invention in deblurring images under significant motion, such as a moving basketball, without compromising on noise performance.

In summary, as illustrated by the comparative results in FIGS. 9A-9C, the disclosed L+S+EVS fusion technique (as shown in L+S+EVS fusion results 915, 925, 935) consistently provides sharp image quality while maintaining a low noise level across various dynamic scenes. This performance is superior to conventional methods, which often present trade-offs between sharpness and noise, or suffer from residual blur and ghosting artifacts. The invention effectively addresses these long-standing challenges in image deblurring by intelligently combining long exposure CIS frames, short exposure CIS frames, and event data from an EVS.

The present disclosure provides significant inventive elements that enhance image deblurring capabilities, particularly in the context of CMOS image sensors fused with event vision sensors. A key inventive element is the fusion of a very short exposed frame (S) together with an L+EVS deblurring output to significantly improve reconstruction quality. This synergistic combination leverages the inherent sharpness of the short exposure in dynamic regions and the high signal-to-noise ratio and deblurred quality of the long exposure frame that has been processed with event data.

Another inventive aspect involves deblurring the long exposure frame (L) to a precise time reference that falls within the short exposure(S) period. This strategic temporal alignment, performed during the deblurring process itself, advantageously obviates the need for a separate, computationally intensive motion alignment process between the long-exposed frame and the short-exposed frame. After this deblurring step, the long-exposed frame is already temporally aligned with the short-exposed frame, streamlining the subsequent fusion. By employing this proposed method, the system offers several notable benefits:
It avoids the need for explicit optical flow estimation, thereby substantially reducing computational effort requirements.
It eliminates the risk of generating distorted frames, which can often arise from inaccurate or undefined optical flow estimations in conventional deblurring techniques.
It increases the generality and applicability of the fusion algorithm to a broader range of challenging scenarios, including those with little texture where reliable optical flow estimation is typically not possible.

These inventive elements lead to several distinct technical advantages for the disclosed image deblurring system:
Low power, real-time processing for on-chip deblurring: The algorithms and architecture are designed for efficient execution, enabling real-time deblurring directly on-chip or within resource-constrained mobile devices.
High signal-to-noise ratio (SNR) for static regions: This is robustly extracted from the L frame enhanced by EVS deblurring, ensuring excellent image quality in non-moving areas even under low-light conditions.
More confident and robust motion mask selection: The intelligent mask generation strategy, as discussed in relation to FIG. 5, benefits from the inherent temporal alignment achieved in Step 1 in FIG. 2, which means no extra, complex motion alignment is required for reliable mask selection. This ensures that the fusion process accurately blends relevant information from each frame without introducing artifacts.

These inventive elements discussed in the present disclosure lead to several distinct technical advantages for the disclosed image deblurring system. The system enables low power, real-time processing for on-chip deblurring, as the event-based approach avoids computationally intensive optical flow estimation. It provides high signal-to-noise ratio (SNR) for static regions, which is robustly extracted from the L frame enhanced by EVS deblurring, ensuring excellent image quality in non-moving areas even under low-light conditions. Furthermore, the system achieves more confident and robust motion mask selection with no extra motion alignment required, as the deblurring process inherently provides temporal alignment, contributing to superior fusion results.

In some embodiments of the present disclosure, the system includes a computer-readable medium, which includes memory media and storage media. The computer-readable medium, or alternatively the non-volatile memory within the computer-readable medium, may include a non-transitory computer-readable storage medium. In some implementations, the computer-readable medium and/or the non-transitory computer-readable storage medium of the computer-readable medium, stores programs, modules, and data structures, or a subset or superset thereof. Applications and/or an operating system embodied as computer-readable instructions on the computer-readable medium can be executed by the computer processor to provide some of the functionalities described above.

While the principles and embodiments described herein are illustrated with respect to image deblurring, it is expressly contemplated that the disclosed methods, systems, and devices are equally applicable to, and fully encompass, video deblurring. Video deblurring introduces distinct challenges, particularly requiring algorithms capable of high-speed execution to facilitate real-time or near real-time processing and maintain continuous data streams with strict latency constraints for user experience.

The foregoing outlines features of several embodiments so that those skilled in the art may better understand aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An imaging system, comprising:
a hybrid image sensor, comprising:
an event driven sensing array including a plurality of event vision sensor (EVS) pixels arranged in EVS pixel rows, wherein one of the plurality of EVS pixels is configured to capture first EVS data corresponding to contrast information of light incident on that EVS pixel within a first time interval, and
a pixel array including a plurality of CMOS image sensor (CIS) pixels arranged in CIS pixel rows, wherein one of the plurality of CIS pixels is configured to capture first CIS data corresponding to intensity of light incident on the CIS pixel within a second time interval and to capture second CIS data corresponding to intensity of light incident on the CIS pixel within a third time interval; and
a control circuitry configured to receive the first EVS data, the first CIS data, and the second CIS data, the control circuitry configured to perform operations comprising:
using the first EVS data to deblur the first CIS data,
generating fusion masks and fusion weights at least partially based on at least one of the first EVS data, the first CIS data and the second CIS data, and
fusing the deblurred first CIS data and the second CIS data with the fusion masks and the fusion weights,
wherein the second time interval precedes the third time interval.

2. The imaging system according to claim 1, wherein the first time interval is longer than the second time interval.

3. The imaging system according to claim 1, wherein the second time interval is longer than the third time interval.

4. The imaging system according to claim 1, wherein generating the fusion masks includes identifying a possible ghost region by analyzing the first EVS data.

5. The imaging system according to claim 1, wherein generating the fusion masks includes identifying a high spatial frequency region by analyzing the second CIS data.

6. The imaging system according to claim 1, wherein of generating the fusion masks includes identifying ghost and large-error regions by analyzing the first EVS data, the first CIS data, and the second CIS data.

7. The imaging system according to claim 1, wherein generating the fusion weights includes determining a pixel-wise fusion weight based on the fusion masks.

8. The imaging system according to claim 1, wherein the one of the plurality of EVS pixels is configured to capture second EVS data corresponding to contrast information of light incident on that EVS pixel within the third time interval.

9. The imaging system according to claim 8, wherein the control circuitry is configured to further perform:
before fusing the deblurred first CIS data and the second CIS data with the fusion masks and the fusion weights, using the second EVS data to deblur the second CIS data; and
instead of the second CIS data, fusing the deblurred first CIS data and the deblurred second CIS data with the fusion masks and the fusion weights.

10. The imaging system according to claim 1, wherein the one of the plurality of CIS pixels is configured to capture third CIS data corresponding to intensity of light incident on the CIS pixel within a fourth time interval, and wherein the one of the plurality of EVS pixels is configured to capture second EVS data corresponding to contrast information of light incident on that EVS pixel within a fifth time interval.

11. The imaging system according to claim 10, wherein the control circuitry is configured to further perform:
using the second EVS data to deblur the third CIS data, and
generating fusion masks and fusion weights at least partially based on the third CIS data or the second EVS data,
wherein fusing the deblurred first CIS data and the second CIS data with the fusion masks and the fusion weights further includes fusing the deblurred first CIS data, the second CIS data and the deblurred third CIS data with the fusion masks and the fusion weights.

12. A method of operating an imaging system including a hybrid image sensor comprising a plurality of event vison sensor (EVS) pixels and a plurality of CMOS image sensor (CIS) pixels in an image array, the method comprising:
receiving, by a control circuitry, first event vision sensor (EVS) data captured from the hybrid image sensor and corresponding to contrast information of light incident on an EVS pixel included in the plurality of EVS pixels of the hybrid image sensor within a first time interval;
receiving, by the control circuitry, first CMOS image sensor (CIS) data captured from the hybrid image sensor and corresponding to intensity of light incident on a CIS pixel included in the plurality of CIS pixels of the hybrid image sensor within a second time interval;
receiving, by the control circuitry, second CIS data captured from the hybrid image sensor and corresponding to intensity of light incident on the CIS pixel within a third time interval;
deblurring, by the control circuitry, the first CIS data with the first EVS data;
generating, by the control circuitry, fusion masks and fusion weights at least partially based on at least one of the first EVS data, the first CIS data and the second CIS data; and
fusing, by the control circuitry, the deblurred first CIS data and the second CIS data with the fusion masks and the fusion weights,
wherein the second time interval precedes the third time interval.

13. The method according to claim 12, wherein the first time interval is longer than the second time interval.

14. The method according to claim 12, wherein the second time interval is longer than the third time interval.

15. The method according to claim 12, wherein generating the fusion masks includes identifying a possible ghost region by analyzing the first EVS data.

16. The method according to claim 12, wherein generating the fusion masks includes identifying a high spatial frequency region by analyzing the second CIS data.

17. The method according to claim 12, wherein generating the fusion masks includes identifying ghost and large-error regions by analyzing the first EVS data, the first CIS data, and the second CIS data.

18. The method according to claim 12, wherein generating the fusion weights includes determining a pixel-wise fusion weight based on the fusion masks.

19. The method according to claim 12, wherein the one of the plurality of EVS pixels is configured to capture second EVS data corresponding to contrast information of light incident on that EVS pixel within the third time interval.

20. The method according to claim 19, wherein the method further comprises:
before fusing the deblurred first CIS data and the second CIS data with the fusion masks and the fusion weights, deblurring, by the control circuitry, the second CIS data with the second EVS data to; and
instead of the second CIS data, fusing, by the control circuitry, the deblurred first CIS data and the deblurred second CIS data with the fusion masks and the fusion weights.

21. The method according to claim 12, wherein the method further comprises:
receiving, by the control circuitry, third CMOS image sensor (CIS) data captured from the hybrid image sensor and corresponding to intensity of light incident on the CIS pixel of the hybrid image sensor within a fourth time interval; and
receiving, by the control circuitry, second event vision sensor (EVS) data captured from the hybrid image sensor and corresponding to contrast information of light incident on the EVS pixel of the hybrid image sensor within a fifth time interval.

22. The method according to claim 21, wherein the method further comprises:
deblurring, by the control circuitry, the third CIS data with the second EVS data; and
generating, by the control circuitry, fusion masks and fusion weights at least partially based on the third CIS data or the second EVS data,
wherein fusing the deblurred first CIS data and the second CIS data with the fusion masks and the fusion weights further includes fusing the deblurred first CIS data, the second CIS data and the deblurred third CIS data with the fusion masks and the fusion weights.

23. A computer-readable medium storing instructions that cause one or more processor to perform the following steps:
receiving first event vision sensor (EVS) data captured from the hybrid image sensor and corresponding to contrast information of light incident on an EVS pixel of the hybrid image sensor within a first time interval;
receiving first CMOS image sensor (CIS) data captured from the hybrid image sensor and corresponding to intensity of light incident on a CIS pixel of the hybrid image sensor within a second time interval;
receiving second CIS data captured from the hybrid image sensor and corresponding to intensity of light incident on the CIS pixel within a third time interval;
deblurring the first CIS data with the first EVS data;
generating, by the control circuitry, fusion masks and fusion weights at least partially based on at least one of the first EVS data, the first CIS data and the second CIS data; and
fusing, the deblurred first CIS data and the second CIS data with the fusion masks and the fusion weights,
wherein the second time interval precedes the third time interval.
